(19) United States
(12) Patent Application Publication
(10) Pub. No.: US 2025/0163556 A1
(43) Pub. Date: May 22, 2025

(54) Method For Producing Amorphous Alloy Soft Magnetic Powder, Amorphous Alloy Soft Magnetic Powder, Dust Core, Magnetic Element, And Electronic Device

(71) Applicant: SEIKO EPSON CORPORATION, Tokyo (JP)

(72) Inventor: Mayu WATANABE, Hachinohe (JP)

(21) Appl. No.: 18/953,225

(22) Filed: Nov. 20, 2024

(30) Foreign Application Priority Data
Nov. 21, 2023 (JP) 2023-197736

(51) Int. Cl. C22C 45/00; B22F 1/142; H01F 1/153; H01F 3/08; H01F 41/02

(52) U.S. Cl. CPC C22C 45/008; B22F 1/142; H01F 1/15375; B22F 2301/35; C22C 2200/02; C22C 2202/02; H01F 3/08; H01F 41/0246

(57) ABSTRACT

A method for producing an amorphous alloy soft magnetic powder, includes: producing an amorphous alloy powder that has an average particle diameter of 3.0 μm or more and 40.0 μm or less and that is formed of impurities and a composition represented by Feₐ(Si₁₋ₓBₓ)_{b}C_{c}, where 76.0≤a≤81.0, 16.0≤b≤22.0, 0<c≤3.0, and 0.5≤x≤0.9; and performing a heat treatment of heating at 370° C. or higher and 460° C. or lower. When the amorphous alloy soft magnetic powder is pressurized at a pressure of 63.7 MPa to produce a green compact having a mass of 7.0 g, volume resistivity is 3.7×10⁻² [Ω·cm] or less.

The present application is based on, and claims priority from JP Application Serial Number 2023-197736, filed Nov. 21, 2023, the disclosure of which is hereby incorporated by reference herein in its entirety.

### BACKGROUND

### 1. Technical Field

The present disclosure relates to a method for producing an amorphous alloy soft magnetic powder, an amorphous alloy soft magnetic powder, a dust core, a magnetic element, and an electronic device.

### 2. Related Art

In JP-A-2022-175110, a soft magnetic powder according to an application example of the present disclosure includes amorphous metal particles having a composition represented by a composition formula Fe_{100-a-b-c-d-e-f-g}CrₐSi_{b}B_{c}C_{d}AlₑTi_{f}Co_{g} (where a, b, c, d, e, f, and g are numbers representing atomic % and satisfy 0<a≤3.0, 5.0≤b≤15.0, 7.0≤c≤15.0, 0.1≤d≤3.0, 0<e≤0.016, 0<f≤0.009, and 0≤g≤0.025). According to such a configuration, it is possible to obtain a soft magnetic powder that has good magnetic properties due to an amorphous alloy and also has low coercive force.

JP-A-2022-175110 discloses that heat treatment is performed in the production of the soft magnetic powder. By performing the heat treatment, it is possible to reduce various defects and anisotropy (stress-induced anisotropy) that are introduced during the production of the soft magnetic powder. Accordingly, the low coercive force can be achieved. Further, JP-A-2022-175110 discloses that a heating temperature in the heat treatment is set to a temperature lower than a crystallization temperature of the amorphous metal particles.

However, from the viewpoint of further reducing the coercive force, a method for producing the soft magnetic powder described in JP-A-2022-175110 still has room for improvement. Therefore, there is a problem to improve the production method so that the coercive force can be reliably reduced without impairing production efficiency of the soft magnetic powder.

### SUMMARY

A method for producing an amorphous alloy soft magnetic powder according to an application example of the present disclosure includes:
a powder production step of producing an amorphous alloy powder that has an average particle diameter of 3.0 μm or more and 40.0 μm or less and that is formed of impurities and a composition represented by a composition formula Feₐ(Si₁₋ₓBₓ)_{b}C_{c} expressed in atomic ratio, where a, b, c, and x are 76.0≤a≤81.0, 16.0≤b≤22.0, 0<c≤3.0, and 0.5≤x≤0.9; and
a heat treatment step of subjecting the amorphous alloy powder to a heat treatment at a temperature of 370° C. or higher and 460° C. or lower to produce an amorphous alloy soft magnetic powder,
when the amorphous alloy soft magnetic powder is pressurized at a pressure of 63.7 MPa to produce a green compact having a mass of 7.0 g, volume resistivity of the green compact is 3.7×10⁻² [Ω·cm] or less.

An amorphous alloy soft magnetic powder according to an application example of the present disclosure includes:
impurities and a composition represented by a composition formula Feₐ(Si₁₋ₓBₓ)_{b}C_{c} expressed in atomic ratio,
where a, b, c, and x are 76.0≤a≤81.0, 16.0≤b≤22.0, 0<c≤3.0, and 0.5≤x≤0.9,
the amorphous alloy soft magnetic powder has an average particle diameter of 3.0 μm or more and 40.0 μm or less, and
when the amorphous alloy soft magnetic powder is pressurized at a pressure of 63.7 MPa to produce a green compact having a mass of 7.0 g, volume resistivity of the green compact is 3.7×10⁻² [Ω·cm] or less.

A dust core according to an application example of the present disclosure includes: the amorphous alloy soft magnetic powder according to the application example of the present disclosure.

A magnetic element according to an application example of the present disclosure includes: a dust core according to the application example of the present disclosure.

An electronic device according to an application example of the present disclosure includes: the magnetic element according to the application example of the present disclosure.

### BRIEF DESCRIPTION OF THE DRAWINGS

FIG. 1 is a process diagram showing a configuration of a method for producing an amorphous alloy soft magnetic powder according to an embodiment.

FIG. 2 is a plan view schematically showing a toroidal type coil component.

FIG. 3 is a transparent perspective view schematically showing a closed magnetic circuit type coil component.

FIG. 4 is a perspective view showing a mobile personal computer which is an electronic device including a magnetic element according to the embodiment.

FIG. 5 is a plan view showing a smartphone which is an electronic device including the magnetic element according to the embodiment.

FIG. 6 is a perspective view showing a digital still camera which is an electronic device including the magnetic element according to the embodiment.

### DESCRIPTION OF EMBODIMENTS

Hereinafter, a method for producing an amorphous alloy soft magnetic powder, an amorphous alloy soft magnetic powder, a dust core, a magnetic element, and an electronic device according to the present disclosure will be described in detail based on preferred embodiments shown in the accompanying drawings.

### 1. Amorphous Alloy Soft Magnetic Powder

First, an amorphous alloy soft magnetic powder according to an embodiment will be described.

The amorphous alloy soft magnetic powder is applicable to any application, and is used, for example, for the production of a dust core. The dust core is produced by bonding particles of the amorphous alloy soft magnetic powder together and compacting the particles.

The amorphous alloy soft magnetic powder according to the embodiment is formed of impurities and a composition represented by a composition formula Feₐ(Si₁₋ₓBₓ)_{b}C_{c} expressed in atomic ratio [where a, b, c, and x are 76.0≤a≤81.0, 16.0≤b≤22.0, 0<c≤3.0, and 0.5≤x≤0.9].

The amorphous alloy soft magnetic powder according to the embodiment has an average particle diameter of 3.0 μm or more and 40.0 μm or less.

Further, when the amorphous alloy soft magnetic powder according to the embodiment is pressurized at a pressure of 63.7 MPa to produce a green compact having a mass of 7.0 g, volume resistivity of the green compact is 3.7×10⁻² [Ω·cm] or less.

According to such a configuration, it is possible to obtain the amorphous alloy soft magnetic powder having a low coercive force. When the volume resistivity of the above-described green compact is within the above range, a variation in coercive force can be reduced. That is, although the amorphous alloy soft magnetic powder is an aggregate of a large amount of particles, when the coercive force is measured by dividing it into a plurality of particle groups, a variation in measurement result can be kept small. Accordingly, for example, when a product such as a dust core is produced using the amorphous alloy soft magnetic powder, a product with stable properties can be produced.

### 1.1. Composition

Hereinafter, a composition of the amorphous alloy soft magnetic powder will be described in detail. As described above, the amorphous alloy soft magnetic powder according to the embodiment has a composition represented by a composition formula Feₐ(Si₁₋ₓBₓ)_{b}C_{c}. The composition formula represents a ratio in terms of the number of atoms in a composition containing four elements of Fe, Si, B, and C.

Fe (iron) greatly affects basic magnetic properties and mechanical properties of the amorphous alloy soft magnetic powder according to the embodiment.

A content of Fe is not particularly limited, and is set such that Fe is a main component, that is, the ratio in terms of the number of atoms is the highest in the amorphous alloy soft magnetic powder.

a represents a ratio of Fe in terms of the number of atoms, which is 76.0≤a≤81.0, preferably 77.0≤a≤80.7, and more preferably 78.0≤a≤80.5. When a is less than a lower limit value, magnetic properties and corrosion resistance are deteriorated. On the other hand, when a is more than an upper limit value, the amorphous alloy soft magnetic powder is likely to be crystallized during production. In addition, it is difficult to reduce the coercive force of the amorphous alloy soft magnetic powder.

When the amorphous alloy soft magnetic powder is produced from a raw material, Si (silicon) promotes amorphization and enhances permeability of the amorphous alloy soft magnetic powder. Accordingly, high permeability and low coercive force can be achieved.

B (boron) promotes the amorphization when the amorphous alloy soft magnetic powder is produced from a raw material. In particular, by using Si and B in combination, the amorphization can be synergistically promoted based on a difference in an atomic radius between Si and B. Accordingly, high permeability and low coercive force can be sufficiently achieved.

x represents a ratio of the number of B atoms to the total number of atoms when the total of the number of Si atoms and the number of B atoms is 1. In the amorphous alloy soft magnetic powder according to the present embodiment, x is 0.5≤x≤0.9, and preferably 0.6≤x≤0.8. Accordingly, a balance between the number of Si atoms and the number of B atoms can be optimized. When x is less than the lower limit value or more than the upper limit value, the balance between the number of Si atoms and the number of B atoms is lost, making it difficult to achieve the amorphization, for example, when attempting to enhance the magnetic properties by enhancing the ratio of Fe.

b represents a total ratio of Si and B, and is 16.0≤b≤22.0, preferably 17.0≤b≤21.0, and more preferably 18.0≤b≤20.0. When b is less than the lower limit value or more than the upper limit value, the amorphous alloy soft magnetic powder is likely to be crystallized during production.

A content of Si is preferably 3.0 atomic % or more and 8.0 atomic % or less, and more preferably 5.0 atomic % or more and 7.0 atomic % or less.

A content of B is preferably 10.0 atomic % or more and 15.5 atomic % or less, and more preferably 12.5 atomic % or more and 14.5 atomic % or less.

Carbon (C) lowers the viscosity of a molten material when the raw material for the amorphous alloy soft magnetic powder is melted, facilitating amorphization and pulverization. Accordingly, an amorphous alloy soft magnetic powder having a small diameter and high permeability can be obtained. As a result, an eddy current loss can be reduced even in a high-frequency range.

c represents a content of C, which is 0<c≤3.0, preferably 1.0≤c≤2.8, and more preferably 1.5≤c≤2.5. When c is less than the lower limit value, the viscosity of the molten material does not sufficiently decrease, and a shape of the particles is irregular. Therefore, a filling property during compaction is reduced, and a saturation magnetic flux density and the permeability of the green compact cannot be sufficiently enhanced. On the other hand, when c is more than an upper limit value, the amorphous alloy soft magnetic powder is likely to be crystallized during production.

The amorphous alloy soft magnetic powder according to the embodiment may contain a trace amount of an additive element in addition to the composition expressed by the composition formula Feₐ(Si₁₋ₓBₓ)_{b}C_{c} as described above. Examples of trace amounts of additive elements include S (sulfur) and P (phosphorus). By containing these, the viscosity of the molten material can be particularly reduced. As a result, spheroidization of the particles can be achieved, and the filling property can be enhanced. In addition, these elements are semimetallic elements and contribute to improving an amorphous forming ability. Therefore, the amorphous alloy soft magnetic powder containing these additive elements has a high degree of amorphization even if the content of Fe is high, and can achieve both high permeability and low coercive force.

The content of S is not particularly limited, and is preferably 0.0010 mass % or more and 0.0100 mass % or less, more preferably 0.0015 mass % or more and 0.0080 mass % or less, and still more preferably 0.0020 mass % or more and 0.0070 mass % or less. When the content of S is less than the lower limit value, an effect of promoting spheroidization or improving the amorphous forming ability may not be sufficiently obtained. On the other hand, when the content of S is more than the upper limit value, an addition amount is excessive, which may hinder the promotion of the spheroidization and the improvement of the amorphous forming ability.

A content of P is not particularly limited, and is preferably 0.0010 mass % or more and 0.0200 mass % or less, more preferably 0.0015 mass % or more and 0.0180 mass % or less, and still more preferably 0.0050 mass % or more and 0.0150 mass % or less. When the content of P is less than the lower limit value, an effect of promoting spheroidization or improving amorphous forming ability may not be sufficiently obtained. On the other hand, when the content of P is more than the upper limit value, an addition amount is excessive, which may hinder the promotion of the spheroidization and the improvement of the amorphous forming ability.

In addition, by adding both S and P, the amorphous forming ability can be particularly enhanced. In this case, a ratio S/P of the content of S to the content of P is preferably 0.2 or more and 0.8 or less, and more preferably 0.3 or more and 0.6 or less. By setting S/P within the above range, it is possible to promote the spheroidization and improve the amorphous forming ability while reducing the contents of S and P. That is, by setting the S/P within the above range, it is possible to obtain an amorphous alloy soft magnetic powder having high magnetic properties during compaction and low coercive force.

In addition, the amorphous alloy soft magnetic powder according to the embodiment may contain, in addition to the elements described above, any other element such as an additive element or impurities. A total content of the other elements is preferably 1.0 mass % or less, more preferably 0.2 mass % or less, and still more preferably 0.1 mass % or less. When the content is within the range, an effect of the present disclosure is less likely to be inhibited by the other elements, and the content is acceptable.

Although the composition of the amorphous alloy soft magnetic powder according to the embodiment is described in detail above, the composition and impurities described above are identified by the following analysis method.

Examples of the analysis method include iron and steel-atomic absorption spectrometry defined in JIS G 1257:2000, iron and steel-ICP emission spectrometry defined in JIS G 1258:2007, iron and steel-spark discharge emission spectrometry defined in JIS G 1253:2002, iron and steel-fluorescent X-ray spectrometry defined in JIS G 1256:1997, and gravimetric, titration and absorption spectrometric methods defined in JIS G 1211 to JIS G 1237.

Specific examples include a solid-state optical emission spectrometer manufactured by SPECTRO, in particular a spark discharge optical emission spectrometer, model: SPECTROLAB, type: LAVMB08A, and an ICP device CIROS120 manufactured by Rigaku Corporation.

In particular, when identifying carbon (C) and sulfur (S), an infrared absorption method after combustion in a current of oxygen (combustion in high frequency induction furnace) defined in JIS G 1211:2011 is also used. Specific examples thereof include a carbon-sulfur analyzer CS-200 made by LECO Corporation.

Further, when nitrogen (N) and oxygen (O) are identified, methods for determination of nitrogen content for an iron and steel defined in JIS G 1228:1997 and general rules for determination of oxygen in metal materials defined in JIS Z 2613:2006 are also used. Specifically, examples thereof include an oxygen and nitrogen analyzer, TC-300/EF-300, manufactured by LECO Corporation.

If necessary, an insulating film may be formed on a surface of each particle of the obtained amorphous alloy soft magnetic powder. A material of the insulating film is not particularly limited, and examples thereof include inorganic materials such as a phosphate such as magnesium phosphate, calcium phosphate, zinc phosphate, manganese phosphate, and cadmium phosphate, and a silicate such as sodium silicate.

### 1.2. Powder Properties

An average particle diameter D50 of the amorphous alloy soft magnetic powder is 3.0 μm or more and 40.0 μm or less, preferably 10.0 μm or more and 35.0 μm or less, and more preferably 20.0 μm or more and 30.0 μm or less. Such an amorphous alloy soft magnetic powder is prevented from being crystallized by heat treatment, and a stress strain is sufficiently relaxed. Therefore, a low coercive force is likely to be achieved. Since the average particle diameter is relatively small, it contributes to realization of a magnetic element having a small eddy current loss.

In particular, when the average particle diameter D50 is 20.0 μm or more and 40.0 μm or less, it is possible to obtain an amorphous alloy soft magnetic powder suitable for mixing with another soft magnetic powder having an average particle diameter smaller than the average particle diameter D50. That is, when the amorphous alloy soft magnetic powder having the average particle diameter D50 within the range is mixed with another soft magnetic powder having a smaller diameter and subjected to compaction-molding, it contributes to further increasing the density of the dust core compared to when the amorphous alloy soft magnetic powder and another soft magnetic powder are subjected to the compaction-molding independently. In addition, the amorphous alloy soft magnetic powder having the average particle diameter D50 within the above range has a high degree of amorphization even with a large diameter, and thus contributes to realization of a magnetic element having high permeability and a low coercive force.

The average particle diameter D50 of the amorphous alloy soft magnetic powder is obtained as a particle diameter at 50% cumulative from a small diameter side in a volume-based particle size distribution obtained by a laser diffraction method.

When the average particle diameter of the amorphous alloy soft magnetic powder is less than the lower limit value, the particle diameter is too small, and therefore, the filling property during compaction-molding may not be sufficiently enhanced. Further, crystallization due to the heat treatment may occur. On the other hand, when the average particle diameter of the amorphous alloy soft magnetic powder is more than the upper limit value, the particle diameter is too large, and therefore, the degree of amorphization may not be sufficiently enhanced. The relaxation of the stress strain due to the heat treatment may be insufficient, making it difficult to achieve a low coercive force.

For the amorphous alloy soft magnetic powder, in the volume-based particle size distribution obtained by the laser diffraction method, when a particle diameter at 10% cumulative from the small diameter side is defined as D10 and a particle diameter at 90% cumulative from the small diameter side is defined as D90, it is preferable that (D90−D10)/D50 is about 1.3 or more and 3.0 or less, and more preferably about 1.8 or more and 2.5 or less. (D90 D10)/D50 is an index showing a degree of spread of particle size distribution, and by having the index within the above range, the filling property of the amorphous alloy soft magnetic powder is particularly good. Accordingly, it is possible to obtain an amorphous alloy soft magnetic powder capable of producing a magnetic element having particularly high permeability.

### 1.3. Magnetic Properties

The coercive force of the amorphous alloy soft magnetic powder according to the embodiment is preferably 119 [A/m] or less (1.5 [Oe] or less), more preferably 24 [A/m] or more (0.3 [Oe] or more) and 95 [A/m] or less (1.2 [Oe] or less), and still more preferably 40 [A/m] or more (0.5 [Oe] or more) and 80 [A/m] or less (1.0 [Oe] or less).

By using the amorphous alloy soft magnetic powder having a particularly low coercive force, a magnetic element capable of sufficiently reducing a hysteresis loss can be produced.

When the coercive force is less than the lower limit value, it is difficult to stably produce such an amorphous alloy soft magnetic powder having a low coercive force, and when the coercive force is pursued too much, the permeability may be adversely affected. On the other hand, when the coercive force is more than the upper limit value, the hysteresis loss is increased, and thus an iron loss of the dust core may be increased.

The coercive force of the amorphous alloy soft magnetic powder can be measured, for example, by a vibrating sample magnetometer such as TM-VSM1230-MHHL manufactured by Tamakawa Co., Ltd.

The saturation magnetic flux density of the amorphous alloy soft magnetic powder according to the embodiment is preferably 1.60 [T] or more and 2.20 [T] or less, more preferably 1.60 [T] or more and 2.10 [T] or less, and still more preferably 1.65 [T] or more and 2.00 [T] or less.

By using the amorphous alloy soft magnetic powder having a relatively high saturation magnetic flux density, the magnetic element can be reduced in size and increased in output.

When the saturation magnetic flux density is less than the lower limit value, it may be difficult to reduce the size and increase the output of the magnetic element. On the other hand, when the saturation magnetic flux density is more than the upper limit value, it is difficult to stably produce the amorphous alloy soft magnetic powder having such a saturation magnetic flux density, and when the saturation magnetic flux density is pursued too much, it may affect the coercive force and lead to an increase in the coercive force.

The saturation magnetic flux density of the amorphous alloy soft magnetic powder is measured by the following method.

First, a true specific gravity p of the soft magnetic powder is measured by a full-automatic gas substitution type densitometer AccuPyc 1330 manufactured by Micromeritics Corporation. Next, a maximum magnetization Mm of the soft magnetic powder is measured by a vibrating sample magnetometer, VSM system, TM-VSM1230-MHHL manufactured by Tamakawa Co., Ltd. Then, the saturation magnetic flux density Bs is calculated by the following formula.

Bs=4π/10000×ρ×Mm

The permeability of the amorphous alloy soft magnetic powder according to the embodiment at a measurement frequency of 100 kHz is preferably 18.0 or more, and more preferably 20.0 or more. Such an amorphous alloy soft magnetic powder is resistant to saturation of the magnetic flux density even when a high magnetic field is applied, and therefore contributes to the realization of a dust core with high saturation magnetic flux density or a small dust core. The upper limit value of the permeability is not particularly limited, and is 50.0 or less in consideration of stable production.

The permeability of the amorphous alloy soft magnetic powder is a real part of a complex permeability measured for a toroidal-shaped green compact produced using the amorphous alloy soft magnetic powder. When the green compact is produced, an epoxy resin of 2 mass % of the soft magnetic powder is used as a binder.

### 2. Method for Producing Amorphous Alloy Soft Magnetic Powder

Next, a method for producing the amorphous alloy soft magnetic powder according to the embodiment will be described.

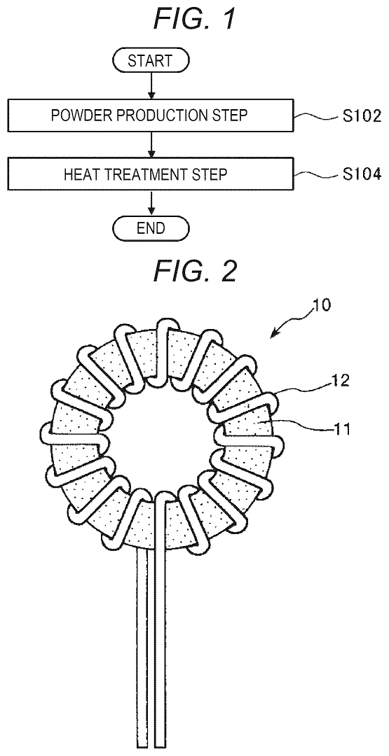

FIG. 1 is a process diagram showing a configuration of the method for producing the amorphous alloy soft magnetic powder according to the embodiment.

The method for producing the amorphous alloy soft magnetic powder shown in FIG. 1 includes a powder production step S102 and a heat treatment step S104.

### 2.1. Powder Production Step

In the powder production step S102, a powder before the heat treatment (amorphous alloy powder) is produced.

The amorphous alloy powder according to the embodiment is a powder formed of an amorphous alloy containing impurities and a composition represented by a composition formula Feₐ(Si₁₋ₓBₓ)_{b}C_{c} expressed in atomic ratio [where a, b, c, and x are 76.0≤a≤81.0, 16.0≤b≤22.0, 0<c≤3.0, and 0.5≤x≤0.9]. The amorphous alloy powder has an average particle diameter of 3.0 μm or more and 40.0 μm or less.

Such an amorphous alloy powder may have a stress strain in a production process or the like. Therefore, by subjecting the amorphous alloy powder to a heat treatment to be described later, the stress strain is relaxed, and a low coercive force is achieved.

A degree of crystallinity of each particle of the amorphous alloy powder is less than 50%, and preferably 30% or less. The degree of crystallinity is calculated based on the following formula by obtaining an X-ray diffraction spectrum for the amorphous alloy powder.

Degree of crystallinity={crystal-derived intensity/(crystal-derived intensity+amorphous-derived intensity)}×100

The amorphous alloy powder may be produced by any production method, and may be produced by, for example, various powdering methods such as atomization methods such as a water atomization method, a gas atomization method, and a rotary water jet atomization method, a reduction method, a carbonyl method, and a pulverization method.

The atomization method is a method for producing a powder by pulverizing a molten raw material and cooling it at the same time by colliding it with a fluid such as a liquid or a gas ejected at a high speed. Examples of the atomization method include a water atomization method, a gas atomization method, and a rotary water jet atomization method, depending on a difference in a type of a cooling medium and a device configuration. Among these, the amorphous alloy powder is preferably produced by the water atomization method or the rotary water jet atomization method, and more preferably produced by the rotary water jet atomization method.

Among these, the “water atomization method” in the present specification refers to a method for producing a metal powder by using a liquid such as water or oil as a coolant, ejecting it in an inverted cone shape that converges to one point, and then allowing a molten metal to flow down toward the convergence point and collide with liquid.

Meanwhile, the “rotary water jet atomization method” in the specification is a method in which a coolant is sprayed and supplied along an inner surface of a cooling cylinder and rotated to form a coolant layer on the inner surface, and a molten metal made by melting an amorphous alloy powder raw material is splashed and brought into contact with the coolant layer. The pulverized molten metal is captured in the coolant layer and is rapidly cooled and solidified. Accordingly, it is possible to obtain the amorphous alloy powder.

In the rotary water jet atomization method, a fairly high cooling rate can be stably maintained by continuously supplying the coolant, which promotes the amorphization of the produced amorphous alloy powder.

The amorphous alloy powder may be subjected to a classification process as necessary. Examples of the classification process include dry classification such as sieving classification, inertial classification, centrifugal classification, and air classification, and wet classification such as sedimentation classification.

### 2.2. Heat Treatment Step

In the heat treatment step S104, the amorphous alloy powder is subjected to the heat treatment at a temperature of 370° C. or higher and 460° C. or lower. Accordingly, the stress strain of the amorphous alloy powder can be relaxed, and it is possible to obtain the amorphous alloy soft magnetic powder having a low coercive force.

In addition, the volume resistivity of the green compact produced using the obtained amorphous alloy soft magnetic powder is 3.7×10⁻² [Ω·cm] or less. Accordingly, it is possible to reduce the variation in the coercive force of the amorphous alloy soft magnetic powder to be produced. The reason why such an effect is obtained is that when the volume resistivity is within the above range, the stress strain is likely to be relaxed in an atomic arrangement or the like. That is, when the volume resistivity of the amorphous alloy soft magnetic powder is within the above range, it is considered that the progress of the heat treatment is less likely to be affected even when a temperature, a time, and the like of the heat treatment vary for each particle. Therefore, it is possible to reduce the coercive force of the entire amorphous alloy soft magnetic powder. In addition, since defective particles due to insufficient or excessive heat treatment are less likely to be generated, the amorphous alloy soft magnetic powder satisfying a predetermined coercive force and having stable quality can be efficiently produced.

It is considered that the volume resistivity of the green compact is relatively strongly affected by insulation between particles. Therefore, for example, in the production process or the heat treatment of the amorphous alloy powder, the prevention of the generation of an oxide is one of methods for reducing the volume resistivity.

The volume resistivity of the green compact is preferably 3.0×10⁻² [Ω·cm] or less, and more preferably 2.5×10⁻² [Ω·cm] or less. Meanwhile, from the viewpoint of efficient production, a lower limit value of the volume resistivity of the green compact is preferably 0.1×10⁻² [Ω·cm] or more, and more preferably 0.5×10⁻² [Ω·cm] or more.

A method for measuring the volume resistivity of the green compact is as follows.

First, 7.0 g of the amorphous alloy soft magnetic powder as a sample is put into a sample container of a powder resistivity measurement probe unit. An inner radius of the sample container is 10.0 mm. A radius of electrodes provided in the sample container is 0.7 mm, an electrode interval is 3.0 mm, and the probe is a four-point probe. Next, the sample is gradually pressurized by a hydraulic pump attached to the unit to prepare a cylindrical green compact having a mass of 7.0 g. With a pressure of 63.7 MPa applied to the green compact, the volume resistivity of the green compact is measured by a resistivity meter connected to the unit. The powder resistivity measurement probe unit used is a powder resistivity measurement system manufactured by Nitto Seiko Analytech Co., Ltd. As the resistivity meter, a low resistivity meter Loresta GP manufactured by Nitto Seiko Analytech Co., Ltd. is used.

The temperature of the heat treatment is 370° C. or higher and 460° C. or lower, preferably 380° C. or higher and 440° C. or lower, and more preferably 390° C. or higher and 430° C. or lower. When the temperature of the heat treatment is within the above range, the stress strain can be sufficiently relaxed while the crystallization of the amorphous alloy powder is prevented.

When the temperature of the heat treatment is less than the lower limit value, the stress strain cannot be sufficiently relaxed, and the coercive force increases. On the other hand, when the temperature of the heat treatment is more than the upper limit value, the amorphous alloy powder may be crystallized.

A time for which the temperature is maintained in the heat treatment (heat treatment time) is preferably 5 minutes or longer and 60 minutes or shorter, more preferably 7 minutes or longer and 45 minutes or shorter, and still more preferably 10 minutes or longer and 30 minutes or shorter. When the heat treatment time is within the above range, the stress strain can be sufficiently relaxed while the crystallization of the amorphous alloy powder is prevented.

When the heat treatment time is less than the lower limit value, the stress strain cannot be sufficiently relaxed, and the coercive force may increase. On the other hand, when the heat treatment time is more than the upper limit value, further effects cannot be expected, and energy efficiency of the heat treatment may decrease.

The heat treatment is performed using, for example, a heat treatment furnace. A pressure in the heat treatment furnace may be an atmospheric pressure, a negative pressure, or a positive pressure. Among these, the positive pressure is preferable. By performing the heat treatment under the positive pressure in the heat treatment furnace, a thermal conductivity of surroundings of the amorphous alloy powder in the heat treatment furnace can be enhanced. Accordingly, the temperature of the amorphous alloy powder can be increased evenly throughout, thereby enabling the amorphous alloy soft magnetic powder as a whole to have a further reduced coercive force.

The pressure in the heat treatment furnace is preferably 10 Pa or more and 1000 Pa or less, more preferably 30 Pa or more and 700 Pa or less, and still more preferably 50 Pa or more and 500 Pa or less. When the pressure in the heat treatment furnace is within the above range, the amorphous alloy soft magnetic powder as a whole can have a further reduced coercive force. In particular, a gas is present in a narrow space between particles of the amorphous alloy powder, and the gas mediates thermal conduction while being affected by a distance between the particles. Therefore, it is considered that a thermal conductivity between the particles is likely to be affected by the pressure.

When the pressure in the heat treatment furnace is less than the lower limit value, the temperature and the like of the heat treatment are likely to vary for each particle, and the heat treatment may be insufficient or excessive in a part. On the other hand, when the pressure in the heat treatment furnace is more than the upper limit value, further effects cannot be expected, and energy efficiency of the heat treatment may decrease.

For example, the positive pressure of 10 Pa is a pressure higher than the atmospheric pressure by 10 Pa, and for example, when the atmospheric pressure is 101.3 kPa, the positive pressure refers to 101.31 kPa.

An atmosphere in the heat treatment furnace is not particularly limited, and may be an acidic atmosphere, a reducing atmosphere, or the like, and is preferably an inert atmosphere, more preferably an inert atmosphere having an oxygen volume concentration of 1500 ppm or less, still more preferably an inert atmosphere having an oxygen volume concentration of 200 ppm to 1000 ppm, and particularly preferably an inert atmosphere having an oxygen volume concentration of 300 ppm to 700 ppm. When the oxygen volume concentration in the inert atmosphere is within the above range, oxidation of the amorphous alloy powder can be prevented more reliably. Therefore, the formation of an oxide film on a surface of the particle can be prevented, and the increase in the volume resistivity of the green compact can be prevented. In addition, when an oxide film is formed, the stress strain may be less likely to be relaxed. In view of this, when the oxygen volume concentration is within the above range, the coercive force of the amorphous alloy powder can be favorably reduced by the heat treatment.

Examples of the inert gas constituting the inert atmosphere include a nitrogen gas and an argon gas.

### 3. Dust Core and Magnetic Element

Next, the dust core and the magnetic element according to the embodiment will be described.

The magnetic element according to the embodiment can be applied to various magnetic elements including a magnetic core, such as choke coils, an inductor, a noise filter, a reactor, a transformer, a motor, an actuator, an electromagnetic valve, and a generator. The dust core according to the embodiment can be applied to a magnetic core provided to these magnetic elements.

Hereinafter, two types of coil components will be representatively described as an example of the magnetic element.

### 3.1. Toroidal Type

First, a toroidal type coil component, which is the magnetic element according to the embodiment, will be described.

FIG. 2 is a plan view schematically showing a toroidal type coil component. The coil component 10 shown in FIG. 2 includes a ring-shaped dust core 11 and a conductive wire 12 wound around the dust core 11.

The dust core 11 is obtained by mixing the amorphous alloy soft magnetic powder described above and a binder, supplying the obtained mixture to a mold, and pressurizing and molding. That is, the dust core 11 is a green compact containing the amorphous alloy soft magnetic powder according to the embodiment. Such a dust core 11 has a low coercive force and a low iron loss.

The coil component 10 includes the dust core 11. Such a coil component 10 has a low iron loss and contributes to power saving of an electronic device.

Examples of a constituent material of the binder used for producing the dust core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate.

Examples of a constituent material of the conductive wire 12 include a material having high conductivity, for example, a metal material including Cu, Al, Ag, Au, and Ni. An insulating coating film is provided on a surface of the conductive wire 12 as necessary.

A shape of the dust core 11 is not limited to the ring shape shown in FIG. 2, and may be, for example, a shape in which a part of the ring is missing, or a shape in which a shape in a longitudinal direction is linear.

The dust core 11 may contain, as necessary, a soft magnetic powder other than the amorphous alloy soft magnetic powder according to the embodiment described above, or a non-magnetic powder. In this case, a ratio of the amorphous alloy soft magnetic powder in a mixed powder obtained by mixing the powders is preferably more than 50 mass %, and more preferably 60 mass % or more.

### 3.2. Closed Magnetic Circuit Type

Next, a closed magnetic circuit type coil component, which is the magnetic element according to the embodiment, will be described.

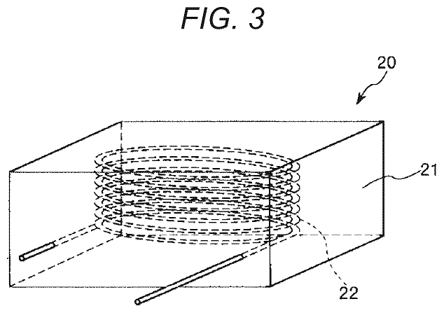

FIG. 3 is a transparent perspective view schematically showing the closed magnetic circuit type coil component.

Hereinafter, the closed magnetic circuit type coil component will be described. In the following description, differences from the toroidal type coil component will mainly be described, and description of similar matters will be omitted.

The coil component 20 shown in FIG. 3 includes a dust core 21 having a chip shape and a conductive wire 22 embedded in the dust core 21 and formed into a coil shape. That is, the dust core 21 is a green compact containing the amorphous alloy soft magnetic powder according to the embodiment. Such a dust core 21 has a low coercive force and a low iron loss.

The coil component 20 includes the dust core 21. Such a coil component 20 has a low iron loss and contributes to power saving of an electronic device.

The dust core 21 may contain, as necessary, a soft magnetic powder other than the amorphous alloy soft magnetic powder according to the embodiment described above, or a non-magnetic powder. In this case, a ratio of the amorphous alloy soft magnetic powder in a mixed powder is preferably more than 50 mass %, and more preferably 60 mass % or more.

### 4. Electronic Device

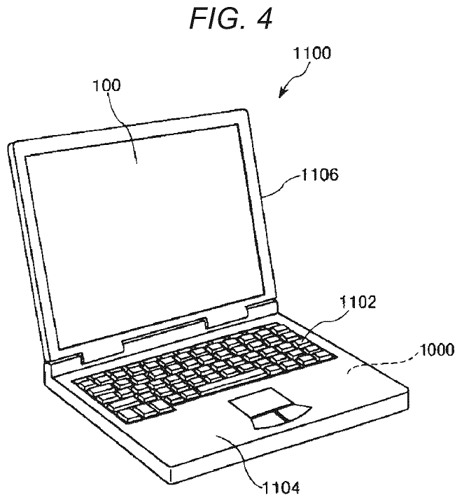

Next, the electronic device including the magnetic element according to the embodiment will be described with reference to FIGS. 4 to 6.

FIG. 4 is a perspective view showing a mobile personal computer which is an electronic device including the magnetic element according to the embodiment. A personal computer 1100 shown in FIG. 4 includes a main body 1104 including a keyboard 1102 and a display unit 1106 including a display 100. The display unit 1106 is rotatably supported by the main body 1104 via a hinge structure. Such a personal computer 1100 includes therein a magnetic element 1000 such as a choke coil, an inductor, or a motor for a switching power supply.

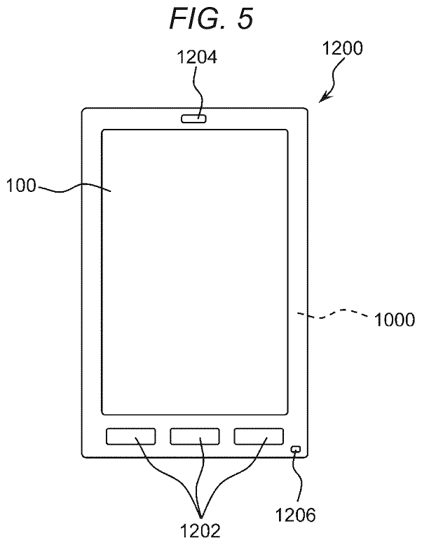

FIG. 5 is a plan view showing a smartphone which is an electronic device including the magnetic element according to the embodiment. The smartphone 1200 shown in FIG. 5 includes a plurality of operation buttons 1202, an earpiece 1204, and a mouthpiece 1206. The display 100 is disposed between the operation buttons 1202 and the earpiece 1204. Such a smartphone 1200 includes therein the magnetic element 1000 such as an inductor, a noise filter, or a motor.

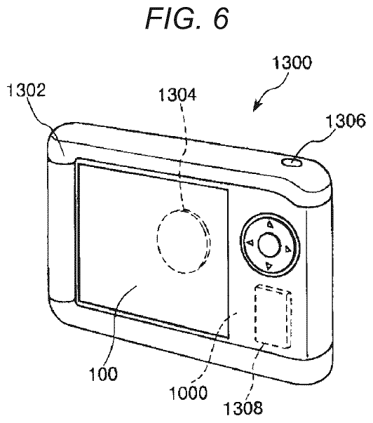

FIG. 6 is a perspective view showing a digital still camera which is an electronic device including the magnetic element according to the embodiment. A digital still camera 1300 photoelectrically converts an optical image of a subject by an imaging element such as a charge coupled device (CCD) so as to generate an imaging signal.

The digital still camera 1300 shown in FIG. 6 includes the display 100 provided at a rear surface of a case 1302. The display 100 functions as a finder which displays a subject as an electronic image. A light receiving unit 1304 including an optical lens, a CCD, and the like is provided on a front surface side of the case 1302, that is, on a back surface side in the drawing.

When a photographer confirms a subject image displayed on the display 100 and presses a shutter button 1306, a CCD imaging signal at this time is transferred to and stored in a memory 1308. Such a digital still camera 1300 also includes therein the magnetic element 1000 such as an inductor or a noise filter.

Examples of the electronic device according to the embodiment include, in addition to the personal computer in FIG. 4, the smartphone in FIG. 5, and the digital still camera in FIG. 6, a mobile phone, a tablet terminal, a watch, inkjet discharge devices such as an inkjet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, medical devices such as an electronic thermometer, a blood pressure meter, a blood glucose meter, an electrocardiogram measurement device, an ultrasonic diagnostic device, and an electronic endoscope, a fish finder, various measuring devices, instruments for a vehicle, an aircraft, and a ship, moving object control devices such as an automobile control device, an aircraft control device, a railway vehicle control device, and a ship control device, and a flight simulator.

Such an electronic device includes the magnetic element according to the embodiment. Accordingly, it is possible to enjoy the advantages of the magnetic element with low iron loss and to achieve power saving of the electronic device.

### 5. Effects of Embodiment

The method for producing the amorphous alloy soft magnetic powder according to the embodiment includes the powder production step S102 and the heat treatment step S104. In the powder production step S102, the amorphous alloy powder having an average particle diameter of 3.0 μm or more and 40.0 μm or less and formed of impurities and a composition represented by a composition formula Feₐ(Si₁₋ₓBₓ)_{b}C_{c} expressed in atomic ratio [where a, b, c, and x are 76.0≤a≤81.0, 16.0≤b≤22.0, 0<c≤3.0, and 0.5≤x≤0.9] is produced. In the heat treatment step S104, the amorphous alloy soft magnetic powder is produced by performing the heat treatment of heating the amorphous alloy powder at a temperature of 370° C. or higher and 460° C. or lower. Further, when the produced amorphous alloy soft magnetic powder is pressurized at a pressure of 63.7 MPa to produce a green compact having a mass of 7.0 g, the green compact has a volume resistivity of 3.7×10⁻² [Ω·cm] or less.

According to such a configuration, the stress strain of the amorphous alloy powder can be sufficiently relaxed, and the amorphous alloy soft magnetic powder having a low coercive force can be efficiently produced. In addition, it is possible to obtain the amorphous alloy soft magnetic powder with less variation in coercive force and stable quality.

The heat treatment time is preferably 5 minutes or longer and 60 minutes or shorter.

According to such a configuration, the stress strain can be sufficiently relaxed while the crystallization of the amorphous alloy powder is prevented.

The coercive force of the amorphous alloy soft magnetic powder is preferably 119 [A/m] or less (1.5 [Oe] or less).

According to such a configuration, it is possible to obtain the amorphous alloy soft magnetic powder capable of producing a magnetic element having particularly low coercive force and sufficiently reduced hysteresis loss.

In the method for producing the amorphous alloy soft magnetic powder according to the embodiment, it is preferable to perform the heat treatment under a pressure of 10 Pa or more and 1000 Pa or less, which is a positive pressure.

According to such a configuration, the amorphous alloy soft magnetic powder as a whole can have a further reduced coercive force. In addition, during the heat treatment, a gas is present in a narrow space between the particles of the amorphous alloy powder, and the gas mediates thermal conduction while being affected by the distance between the particles, and thus it is considered that the thermal conductivity between the particles is likely to be affected by pressure. Therefore, by performing the heat treatment under the above-described pressure, the variation in temperature in the heat treatment can be reduced.

In the method for producing the amorphous alloy soft magnetic powder according to the embodiment, the heat treatment is preferably performed in an inert atmosphere having an oxygen volume concentration of 1500 ppm or less.

According to such a configuration, oxidation of the amorphous alloy powder can be more reliably prevented. In addition, since the formation of the oxide film on the surface of the particle can be prevented, it is possible to prevent the stress strain from being less likely to be relaxed.

The amorphous alloy soft magnetic powder according to the embodiment is formed of impurities and a composition represented by a composition formula Feₐ(Si₁₋ₓBₓ)_{b}C_{c} expressed in atomic ratio [where a, b, c, and x are 76.0≤a≤81.0, 16.0≤b≤22.0, 0<c≤3.0, and 0.5≤x≤0.9], and has an average particle diameter of 3.0 μm or more and 40.0 μm or less. Further, when the amorphous alloy soft magnetic powder according to the embodiment is pressurized at a pressure of 63.7 MPa to produce a green compact having a mass of 7.0 g, a volume resistivity of the green compact is 3.7×10⁻² [Ω·cm] or less.

According to such a configuration, the amorphous alloy soft magnetic powder having a low coercive force is obtained.

The amorphous alloy soft magnetic powder according to the embodiment preferably has a coercive force of 119 [A/m] or less (1.5 [Oe] or less).

According to such a configuration, it is possible to obtain the amorphous alloy soft magnetic powder capable of producing a magnetic element capable of sufficiently reducing hysteresis loss.

The dust core of the pressure powder according to the embodiment includes the amorphous alloy soft magnetic powder according to the embodiment.

According to such a configuration, it is possible to obtain a dust core having a low coercive force and a low iron loss.

The magnetic element according to the embodiment includes the dust core according to the embodiment.

According to such a configuration, the iron loss is low, and it is possible to contribute to power saving of the electronic device.

The electronic device according to the embodiment includes the magnetic element according to the embodiment.

According to such a configuration, it is possible to enjoy the advantages of the magnetic element with low iron loss and to achieve power saving of the electronic device.

The method for producing an amorphous alloy soft magnetic powder, an amorphous alloy soft magnetic powder, a dust core, a magnetic element, and an electronic device according to the present disclosure are described above based on a preferred embodiment, and the present disclosure is not limited thereto. For example, the dust core and the magnetic element according to the present disclosure may be what is obtained by replacing each unit of the embodiment described above with any component having the same function, or what is obtained by adding any constituent to the embodiment described above.

In addition, in the above embodiment, a dust core is described as an example of an application of the amorphous alloy soft magnetic powder of the present disclosure, however, the application example is not limited thereto, and may be, for example, a magnetic fluid, a magnetic shielding sheet, and a magnetic device such as a magnetic head. In addition, shapes of the dust core and the magnetic element are not limited to those shown in the drawings, and any shapes may be adopted.

The method for producing the amorphous alloy soft magnetic powder according to the present disclosure may be one in which any desired process is added to the above embodiment.

### EXAMPLES

Next, specific examples of the disclosure will be described.

### 6. Production of Dust Core

### 6.1. Sample No. 1

First, a raw material was melted in a high-frequency induction furnace and pulverized by a rotary water jet atomization method to obtain an amorphous alloy powder.

Next, the obtained amorphous alloy powder was subjected to the heat treatment under conditions shown in Table 1.

Next, classification was performed by a classifier using a mesh. An alloy composition of the amorphous alloy powder after the classification is shown in Table 1. The alloy composition was determined using a solid-state optical emission spectrometer manufactured by SPECTRO, model: SPECTROLAB, type: LAVMB08A.

Next, the obtained amorphous alloy powder was mixed with an epoxy resin as a binder and toluene as an organic solvent to obtain a mixture. An addition amount of the epoxy resin was 2 parts by mass with respect to 100 parts by mass of the amorphous alloy soft magnetic powder.

Then, the mixture thus obtained was stirred and then dried for a short time to obtain a massive dried body. Next, the dried body was sieved with a sieve having an opening of 400 μm, and the dried body was pulverized to obtain granulated powders. The obtained granulated powders were dried at 50° C. for 1 hour.

Next, the obtained granulated powders were filled in a mold, and a molded body was obtained based on the following molding conditions.

### Molding Conditions

Molding method: press molding
Shape of molded body: ring shape
Dimensions of molded body: outer diameter 14 mm, inner diameter 8 mm, thickness 3 mm
Molding pressure: 0.5 t/cm² (49 MPa)
Molding temperature: 70° C.

Next, the molded body was heated in an air atmosphere at a temperature of 150° C. for 0.50 hours to cure the binder. Accordingly, a dust core was obtained.

Table 2 shows powder properties of the amorphous alloy soft magnetic powder used in the production of the dust core, and volume resistivity of the green compact.

### 6.2. Sample Nos. 2 to 16

A dust core was obtained in the same manner as in the case of Sample No. 1, except that an amorphous alloy soft magnetic powder was used, which was produced under the production conditions shown in Table 1 and had the powder properties and the volume resistivity of the green compact indicated by values shown in Table 2.

For the amorphous alloy soft magnetic powder of sample No. 8, the heat treatment was omitted.

### 6.3. Sample Nos. 17 to 25

A dust core was obtained in the same manner as in the case of Sample No. 1, except that an amorphous alloy soft magnetic powder was used, which was produced under the production conditions shown in Table 3 and had the powder properties and the volume resistivity of the green compact indicated by values shown in Table 4.

In Tables 1 to 4, among the amorphous alloy soft magnetic powders of the respective sample numbers, those produced by a method corresponding to the present disclosure are indicated as “Examples”, and those not corresponding to the present disclosure are indicated as “Comparative Examples”.

TABLE 1

| | | | | | | | | | | | Method for | Heat treatment conditions | | | |
|---|---|---|---|---|---|---|---|---|---|---|---|---|---|---|---|
| | | | | | | | | | | | producing | | | | Oxygen volume |
| | | Composition of amorphous alloy powder | | | | | | | | | amorphous | | | Positive | concentration |
| | | Fe | Si | B | C | a | b | c | x | S/P | alloy | Temperature | Time | pressure | in furnace |
| Sample No. | | Atomic % | | | — | | | — | | | powder | ° C. | Min(s) | Pa | ppm |
| No. 1 | Comparative | 80.0 | 5.4 | 12.6 | 1.9 | 80.0 | 18.0 | 1.9 | 0.7 | 0.5 | Rotary water | 350 | 15 | 300 | 465 |
| | Example | | | | | | | | | | | | | | |
| No. 2 | Example | 80.0 | 5.4 | 12.6 | 1.9 | 80.0 | 18.0 | 1.9 | 0.7 | 0.5 | Rotary water | 370 | 15 | 300 | 523 |
| No. 3 | Example | 80.0 | 5.4 | 12.6 | 1.9 | 80.0 | 18.0 | 1.9 | 0.7 | 0.5 | Rotary water | 390 | 15 | 300 | 478 |
| No. 4 | Example | 80.0 | 5.4 | 12.6 | 1.9 | 80.0 | 18.0 | 1.9 | 0.7 | 0.5 | Rotary water | 410 | 15 | 300 | 625 |
| No. 5 | Example | 80.0 | 5.4 | 12.6 | 1.9 | 80.0 | 18.0 | 1.9 | 0.7 | 0.5 | Rotary water | 430 | 15 | 300 | 684 |
| No. 6 | Example | 80.0 | 5.4 | 12.6 | 1.9 | 80.0 | 18.0 | 1.9 | 0.7 | 0.5 | Rotary water | 460 | 15 | 300 | 602 |
| No. 7 | Comparative | 80.0 | 5.4 | 12.6 | 1.9 | 80.0 | 18.0 | 1.9 | 0.7 | 0.5 | Rotary water | 480 | 15 | 300 | 385 |
| | Example | | | | | | | | | | | | | | |
| No. 8 | Comparative | 80.0 | 5.4 | 12.6 | 1.9 | 80.0 | 18.0 | 1.9 | 0.7 | 0.5 | Rotary water | — | — | — | — |
| | Example | | | | | | | | | | | | | | |
| No. 9 | Example | 80.0 | 5.4 | 12.6 | 1.9 | 80.0 | 18.0 | 1.9 | 0.7 | 0.5 | Rotary water | 410 | 5 | 300 | 468 |
| No. 10 | Example | 80.0 | 5.4 | 12.6 | 1.9 | 80.0 | 18.0 | 1.9 | 0.7 | 0.5 | Rotary water | 410 | 30 | 300 | 632 |
| No. 11 | Example | 80.0 | 5.4 | 12.6 | 1.9 | 80.0 | 18.0 | 1.9 | 0.7 | 0.5 | Rotary water | 410 | 60 | 300 | 650 |
| No. 12 | Example | 80.0 | 5.4 | 12.6 | 1.9 | 80.0 | 18.0 | 1.9 | 0.7 | 0.5 | Rotary water | 410 | 15 | 0 | 1650 |
| No. 13 | Example | 80.0 | 5.4 | 12.6 | 1.9 | 80.0 | 18.0 | 1.9 | 0.7 | 0.5 | Rotary water | 410 | 15 | 50 | 1430 |
| No. 14 | Example | 80.0 | 5.4 | 12.6 | 1.9 | 80.0 | 18.0 | 1.9 | 0.7 | 0.5 | Rotary water | 410 | 15 | 100 | 1020 |
| No. 15 | Example | 80.0 | 5.4 | 12.6 | 1.9 | 80.0 | 18.0 | 1.9 | 0.7 | 0.5 | Rotary water | 410 | 15 | 500 | 540 |
| No. 16 | Example | 80.0 | 5.4 | 12.6 | 1.9 | 80.0 | 18.0 | 1.9 | 0.7 | 0.5 | Rotary water | 410 | 15 | 1000 | 251 |

TABLE 2

| | | | | | | | Evaluation result for amorphous alloy soft | | | |
|---|---|---|---|---|---|---|---|---|---|---|
| | | Composition of amorphous alloy soft magnetic powder | | | | | magnetic powder | | | |
| | | | | | | Volume | | Coercive | | |
| | | | | | (D90 − | resistivity of | Coercive | force | | Permeability |
| | | D10 | D50 | D90 | D10)/ | green compact | force | variation | Iron loss | 100 kHz |
| Sample No. | | μm | μm | μm | D50 | ×10⁻² Ω · cm | Oe | — | kW/m³ | — |
| No. 1 | Comparative | 10.1 | 25.1 | 50.2 | 1.60 | 5.0 | 1.7 | C | 1751 | C |
| | Example | | | | | | | | | |
| No. 2 | Example | 10.1 | 25.1 | 50.2 | 1.60 | 3.2 | 1.4 | B | 1442 | B |
| No. 3 | Example | 10.1 | 25.1 | 50.2 | 1.60 | 2.3 | 1.0 | A | 1030 | A |
| No. 4 | Example | 10.1 | 25.1 | 50.2 | 1.60 | 1.8 | 0.8 | A | 823 | A |
| No. 5 | Example | 10.1 | 25.1 | 50.2 | 1.60 | 2.0 | 0.9 | A | 927 | A |
| No. 6 | Example | 10.1 | 25.1 | 50.2 | 1.60 | 2.9 | 1.3 | A | 1339 | A |
| No. 7 | Comparative | 10.1 | 25.1 | 50.2 | 1.60 | 6.8 | 1.8 | C | 1648 | A |
| | Example | | | | | | | | | |
| No. 8 | Comparative | 10.1 | 25.1 | 50.2 | 1.60 | 8.1 | 3.0 | C | 3090 | C |
| | Example | | | | | | | | | |
| No. 9 | Example | 10.1 | 25.1 | 50.2 | 1.60 | 3.4 | 1.4 | B | 1545 | B |
| No. 10 | Example | 10.1 | 25.1 | 50.2 | 1.60 | 1.6 | 0.7 | A | 730 | A |
| No. 11 | Example | 10.1 | 25.1 | 50.2 | 1.60 | 3.2 | 1.4 | A | 1442 | A |
| No. 12 | Example | 10.1 | 25.1 | 50.2 | 1.60 | 3.7 | 1.5 | B | 1650 | B |
| No. 13 | Example | 10.1 | 25.1 | 50.2 | 1.60 | 2.7 | 1.2 | B | 1310 | B |
| No. 14 | Example | 10.1 | 25.1 | 50.2 | 1.60 | 2.3 | 1.0 | B | 1030 | A |
| No. 15 | Example | 10.1 | 25.1 | 50.2 | 1.60 | 1.6 | 0.7 | A | 715 | A |
| No. 16 | Example | 10.1 | 25.1 | 50.2 | 1.60 | 1.6 | 0.7 | A | 720 | A |

TABLE 3

| | | | | | | | | | | | | Heat treatment conditions | | | |
|---|---|---|---|---|---|---|---|---|---|---|---|---|---|---|---|
| | | | | | | | | | | | Method for | | | | Oxygen |
| | | | | | | | | | | | producing | | | | volume |
| | | Composition of amorphous alloy powder | | | | | | | | | amorphous | | | Positive | concentration |
| | | Fe | Si | B | C | a | b | c | x | S/P | alloy | Temperature | Time | pressure | in furnace |
| Sample No. | | Atomic % | | | | — | | | | — | powder | ° C. | Min(s) | Pa | ppm |
| No. 17 | Example | 79.0 | 5.5 | 13.5 | 1.9 | 79.0 | 19.0 | 1.9 | 0.7 | 0.4 | Rotary | 410 | 15 | 400 | 580 |
| | | | | | | | | | | | water | | | | |
| No. 18 | Example | 76.5 | 7.2 | 14.7 | 1.6 | 76.5 | 21.9 | 1.6 | 0.7 | 0.5 | Rotary | 410 | 15 | 400 | 580 |
| | | | | | | | | | | | water | | | | |
| No. 19 | Example | 80.4 | 4.9 | 12.4 | 2.2 | 80.4 | 17.3 | 2.2 | 0.7 | 0.2 | Rotary | 410 | 15 | 400 | 580 |
| | | | | | | | | | | | water | | | | |
| No. 20 | Example | 78.2 | 6.2 | 13.7 | 1.8 | 78.2 | 19.9 | 1.8 | 0.7 | 0.5 | Rotary | 410 | 15 | 400 | 580 |
| | | | | | | | | | | | water | | | | |
| No. 21 | Example | 79.6 | 5.5 | 12.5 | 2.3 | 79.6 | 18.0 | 2.3 | 0.7 | 0.4 | Rotary | 410 | 15 | 400 | 580 |
| | | | | | | | | | | | water | | | | |
| No. 22 | Example | 79.0 | 5.5 | 13.5 | 1.9 | 79.0 | 19.0 | 1.9 | 0.7 | 0.4 | Water | 410 | 15 | 400 | 580 |
| | | | | | | | | | | | atomization | | | | |
| No. 23 | Example | 78.4 | 6.1 | 13.6 | 1.8 | 78.4 | 19.7 | 1.8 | 0.7 | 0.6 | Water | 410 | 15 | 400 | 580 |
| | | | | | | | | | | | atomization | | | | |
| No. 24 | Example | 80.4 | 4.9 | 12.4 | 2.2 | 80.4 | 17.3 | 2.2 | 0.7 | 0.8 | Water | 410 | 15 | 400 | 580 |
| | | | | | | | | | | | atomization | | | | |
| No. 25 | Comparative | 81.5 | 5.7 | 11.3 | 1.4 | 81.5 | 17.0 | 1.4 | 0.7 | 1.1 | Rotary | 410 | 15 | 400 | 580 |
| | Example | | | | | | | | | | water | | | | |

TABLE 4

| | | | | | | | Evaluation result for amorphous alloy soft | | | |
|---|---|---|---|---|---|---|---|---|---|---|
| | | Composition of amorphous alloy soft magnetic powder | | | | | magnetic powder | | | |
| | | | | | (D90 − | Volume | | Coercive | | |
| | | | | | D10)/ | resistivity of | Coercive | force | | |
| | | D10 | D50 | D90 | D50 | green compact | force | variation | Iron loss | Permeability |
| Sample No. | | μm | μm | μm | — | ×10⁻² Ω · cm | Oe | — | kW/m³ | 100 kHz |
| No. 17 | Example | 9.2 | 22.5 | 48.5 | 1.75 | 2.2 | 1.0 | A | 1025 | A |
| No. 18 | Example | 8.5 | 21.2 | 39.5 | 1.46 | 1.6 | 0.7 | A | 713 | B |
| No. 19 | Example | 8.4 | 32.1 | 55.7 | 1.47 | 2.5 | 1.1 | A | 1150 | B |
| No. 20 | Example | 10.1 | 25.1 | 50.2 | 1.60 | 1.7 | 0.8 | A | 820 | B |
| No. 21 | Example | 11.1 | 29.4 | 55.7 | 1.52 | 2.6 | 1.0 | A | 1016 | A |
| No. 22 | Example | 2.5 | 5.1 | 10.3 | 1.53 | 2.4 | 1.0 | A | 1036 | A |
| No. 23 | Example | 2.0 | 4.7 | 9.4 | 1.57 | 2.2 | 0.9 | A | 930 | B |
| No. 24 | Example | 2.2 | 3.6 | 8.5 | 1.75 | 2.6 | 1.1 | A | 1140 | B |
| No. 25 | Comparative | 9.5 | 24.5 | 48.0 | 1.57 | 11.5 | 5.1 | C | 5260 | A |
| | Example | | | | | | | | | |

### 7. Evaluation for Amorphous Alloy Soft Magnetic Powder

### 7.1. Powder Properties of Amorphous Alloy Soft Magnetic Powder

The amorphous alloy soft magnetic powder obtained in each of the Examples and Comparative Examples was subjected to particle size distribution measurement. The measurement was carried out using a laser diffraction type particle size distribution measurement device, Microtrac HRA9320-X100 manufactured by Nikkiso Co., Ltd. Further, D10, D50, D90, and (D90−D10)/D50 were calculated. Calculation results are shown in Tables 2 and 4.

### 7.2. Coercive Force of Amorphous Alloy Soft Magnetic Powder

The coercive force of the amorphous alloy soft magnetic powder obtained in each of the Examples and Comparative Examples was measured. The measurement results are shown in Tables 2 and 4.

### 7.3. Variation in Coercive Force of Amorphous Alloy Soft Magnetic Powder

The variation in the coercive force of the amorphous alloy soft magnetic powder obtained in each of the Examples and Comparative Examples was evaluated by the following method. The evaluation results are shown in Tables 2 and 4.

First, 5 g of the amorphous alloy soft magnetic powder was prepared and divided into 10 equal parts. Further, the coercive force of each of the equal parts was then measured, and a range of measurement values (difference between a maximum value and a minimum value) was evaluated against the following evaluation criteria.
A: The range of measurement values is particularly small.
B: The range of measurement values is slightly large, but there is little problem in practical use.
C: The range of measurement values is large, and there is a problem in practical use.

### 7.4. Iron Loss of Magnetic Element

Using the dust core obtained in each of Examples and Comparative Examples, the magnetic elements was produced under the following production conditions.
Constituent material of conductive wire: Cu
Wire diameter of conductive wire: 0.16 mm
Number of turns: 18 turns on a primary side, 18 turns on a secondary side

Next, the iron loss of the produced magnetic element was measured under the following measurement conditions. The measurement results are shown in Tables 2 and 4.
Measurement device: BH analyzer SY-8218, manufactured by Iwasaki Electric Co., Ltd.
Measurement frequency: 1000 kHz
Maximum magnetic flux density: 20 mT

### 7.5. Permeability of Magnetic Element

Using the dust core obtained in each of Examples and Comparative Examples, the magnetic elements was produced under the following production conditions.
Constituent material of conductive wire: Cu
Wire diameter of conductive wire: 0.6 mm
Number of turns: 7 turns

Next, the permeability of the produced magnetic element was measured under the following measurement conditions.
Measurement device: Impedance Analyzer 4294A, manufactured by Keysight Technologies
Measurement frequency: 100 kHz

Then, the obtained permeability was evaluated in view of the following evaluation criteria. The evaluation results are shown in Tables 2 and 4.
A: Permeability is 20.0 or more.
B: Permeability is 18.0 or more and less than 20.0.
C: Permeability is less than 18.0.

As shown in Tables 2 and 4, it is found that the amorphous alloy soft magnetic powders obtained in the respective Examples have lower coercive forces than the amorphous alloy soft magnetic powders obtained in the respective Comparative Examples. In addition, the variation in coercive force is kept small.

What is claimed is:

1. A method for producing an amorphous alloy soft magnetic powder, comprising:
a powder production step of producing an amorphous alloy powder that has an average particle diameter of 3.0 μm or more and 40.0 μm or less and that is formed of impurities and a composition represented by a composition formula Feₐ(Si₁₋ₓBₓ)_{b}C_{c} expressed in atomic ratio, where a, b, c, and x are 76.0≤a≤81.0, 16.0≤b≤22.0, 0<c≤3.0, and 0.5≤x≤0.9; and
a heat treatment step of subjecting the amorphous alloy powder to a heat treatment at a temperature of 370° C. or higher and 460° C. or lower to produce an amorphous alloy soft magnetic powder, wherein
when the amorphous alloy soft magnetic powder is pressurized at a pressure of 63.7 MPa to produce a green compact having a mass of 7.0 g, volume resistivity of the green compact is 3.7×10⁻² [Ω·cm] or less.

2. The method for producing an amorphous alloy soft magnetic powder according to claim 1, wherein a heat treatment time is 5 minutes or longer and 60 minutes or shorter.

3. The method for producing an amorphous alloy soft magnetic powder according to claim 1, wherein a coercive force of the amorphous alloy soft magnetic powder is 119 [A/m] or less, that is, 1.5 [Oe] or less.

4. The method for producing an amorphous alloy soft magnetic powder according to claim 1, wherein the heat treatment is performed under a pressure of 10 Pa or more and 1000 Pa or less, which is a positive pressure.

5. The method for producing an amorphous alloy soft magnetic powder according to claim 1, wherein the heat treatment is performed in an inert atmosphere having an oxygen volume concentration of 1500 ppm or less.

6. An amorphous alloy soft magnetic powder comprising:
impurities and a composition represented by a composition formula Feₐ(Si₁₋ₓBₓ)_{b}C_{c} expressed in atomic ratio, where a, b, c, and x are 76.0≤a≤81.0, 16.0≤b≤22.0, 0<c≤3.0, and 0.5≤x≤0.9, wherein
the amorphous alloy soft magnetic powder has an average particle diameter of 3.0 μm or more and 40.0 μm or less, and
when the amorphous alloy soft magnetic powder is pressurized at a pressure of 63.7 MPa to produce a green compact having a mass of 7.0 g, volume resistivity of the green compact is 3.7×10⁻² [Ω·cm] or less.

7. The amorphous alloy soft magnetic powder according to claim 6, wherein
a coercive force is 119 [A/m] or less, that is, 1.5 [Oe] or less.

8. A dust core comprising:
the amorphous alloy soft magnetic powder according to claim 6.

9. A magnetic element comprising:
the dust core according to claim 8.

10. An electronic device comprising:
the magnetic element according to claim 9.
